(19) United States
(12) Patent Application Publication
(10) Pub. No.: US 2006/0288271 A1
(43) Pub. Date: Dec. 21, 2006

(54) Conceptual apportionment and ordering in columns of the written speech for easier comprehensible and fasten readable texts

(76) Inventor: George Gerou, Athens (GR)

Correspondence Address: GEROU GEORGE, VALTINON 24, 114 73, ATHENS, GR

(21) Appl. No.: 11/438,152

(22) Filed: May 22, 2006

(30) Foreign Application Priority Data
May 27, 2005 (GR) 20050100259

(51) Int. Cl. G06F 17/00

(52) U.S. Cl. 715/508

(57) ABSTRACT

Production of printed or otherwise produced easier comprehensible and faster readable texts in the mode of columnar notional arrangement, in which the texts are written in columns and consecutive lines in these columns comprise sets of consecutive words, wherein phrases of the original text have been apportioned so as to constitute partial or self-sufficient notional entities and wherein these lines have their beginnings or their ends lying along a straight line perpendicular to the common direction thereof or wherein these lines have their geometrical means lying along a straight line normally oriented to the direction thereof, such straight lines passing through the geometrical means constituting an axis of symmetry being followed by the reader's eyes after a certain habituation, thereby achieving a more efficient, faster and more relaxed reading, as well as of texts in which the differentiated writing of selected words renders a selected summary.

The proposal entitled “CONCEPTUAL APPORTIONMENT AND ORDERING IN COLUMNS OF THE WRITTEN SPEECH FOR EASIER COMPREHENSIBLE AND FASTER READABLE TEXTS” concerns a method of producing easier comprehensible and faster readable texts, whereby each phrase of the text is split in sets comprising one or more consecutive words. The sets of words constitute in themselves self-sufficient or partial notional entities such as clauses, the subject of a clause with the adjectival complements thereof, the object of a clause with the adjectival complements thereof, the verb with one or more adverbs. Thus, individual words that must be emphasized are the abovementioned sets of words being arranged in consecutive lines of the text in the order in which they appear in the phrase out of which they originated and in the order by which they are being read. The said sets of words thereby form columns and the corresponding texts of this method are produced by means of any kind of equipment whatsoever, such as printing devices, electronic devices, projector devices, etc. The applied today printing portrays the corresponding writing of handwriting, according to which the words of the text are placed in straight lines and in order the next word is always placed on the right of the previous word. In this manner, lines of words are created, which start from the left margin of the page and end at the relevant right margin.

The mode in which communication of a person-transmitter and in our case of the writer with a person-receiver is achieved is not that of transmittal of notions of independent words, but that of transmittal of sets of notions of consecutive words, such notions composing relatively simple or more complex notions. If each one of those partial notions is presumed to correspond to a vertebra, then we might say that the expression has a vertebral structure.

On the other hand, the comprehension by the reader of each one of those notions is not limited in the comprehension of the notions of the word portions thereof, but goes further into a synthesis of the notions of the words of this set, such a synthesis providing the notion that the writer desires to transmit.

Thus, if we assume the process of comprehension of a notion to comprise one vertebra, then we might say that the structure of comprehension of a phrase also is of a vertebral structure and that there is apparently a clear relationship between a vertebra portion of the expression and a corresponding vertebra portion of the comprehension.

If we now wish to characterize the structure of traditional writing, we will observe that it is a continuous quotation of equidistantly spaced words, wherein the beginnings or ends of self-contained notions are not apparent, so that the reader may process the comprehension thereof. On the contrary, the reader has to undergo the unnecessary burden of locating each one of these self-contained notions so as to initiate the process of comprehension thereof.

This additional process has the following adverse consequences: the additional and unnecessary fatigue and waste of time that summarize into tiring the reader without any reason and result into diminishing comprehensive capacity of the reader, whilst in the same time they lead into an increased overall reading time of the whole text due to the additional time wasted in this additional process.

These problems are being solved by the notional apportionment of the phrases of a text, i.e. by the arrangement of each one of the self-contained notions in an independent line of text, thereby offering the notion in a ready to start comprehension process mode and freeing the reader from the carrying out of unnecessary processes.

In the notionally apportioned texts, the reader must immediately locate the first and the last word of a set of words constituting a self-contained notion, thereby being enabled to know where to start and where to terminate the comprehension process and consequently to proceed with the corresponding process of comprehension of the next notion and with the process of synthesis of the portional notions of each phrase in the text, etc.

The number of columns in each page depends on many factors, such as:

The desired width of the page
1. The size of the letters to be used.
2. The nature of the printed material, e.g. whether it is a school textbook and for which educational level it is designed etc.
3. 3 Whether the text is illustrated.
4. Whether we are interested in the brightness of the text, as well as other factors.
   The method of producing this kind of texts is characterized in that the texts are arranged in a columnar notional mode comprising apportionment of the phases contained in the original text in sets comprising one or more consecutive words, said sets of words constituting in themselves self-sufficient or partial conceptional entities, such as small clauses, the subject of a clause with one or more adjectival complements, the object of a clause with one or more adjectival complements, the verb with one or more adverbs thereof, individual words that must be emphasized, said sets of words being contained in consecutive lines of text in the order in which they appear in the phrase out of which they originated and in which order they are being read.
   Each such set may comprise the subject with its adjective, the verb with its adverbs, the verb with its object, the verb with its subject and object, single words, when they express something which must be stressed, as well as anything else the writer believes is necessary to the text.
   Groups of words, such as
   All conductors heat up
   when an electric current
   passes through them.
   When we turn on a kitchen stove,
   its hotplate heats up.
   In general,
   when an electric current
   passes through a resistance,
   its temperature rises.

### BRIEF DESCRIPTION OF THE DRAWINGS

FIG. 1a shows a text from a schoolbook that has been written in the traditional mode.

FIG. 1b shows the text of FIG. 1a that has been transformed in the notional apportionment mode, wherein each line of text comprises a self-sufficient notional entity and wherein all beginnings of all lines lie along a straight line that is normally oriented to the direction of these lines.

FIG. 2a shows the same text as hereinabove, however wherein certain notional entities of the text that need particular attention of the reader since they contain important notions have been typed in bold letters.

FIG. 2b shows the same traditionally written text of FIG. 1a, wherein certain notional entities of the text that need particular attention of the reader since they contain important notions have been typed in bold letters.

FIG. 3 shows a text that has been written in the traditional mode.

FIG. 4 shows the same text as in FIG. 3 notionally apportioned, wherein apportionment has been made in as simpler notions as possible in order to render it more easily comprehensible. In this text the beginnings of all lines lie along a straight line, perpendicular to the direction thereof.

FIG. 5 also shows the same text as in FIG. 3, similarly apportioned as in FIG. 4, however in this Figure it is the ends of all lines that lie along a straight line, perpendicular to the direction thereof.

FIGS. 6 and 7 also show the same text as in FIG. 3, however with the difference that the means of all lines lie along a straight line that is perpendicularly oriented to the direction of these lines, thereby this straight line constituting an axis of symmetry of the overall column. This form has proved to offer the best results, since following a certain familiarization in reading texts of such form, their reading is made possible through a linear movement of the glance of the reader along their axis of symmetry, thereby such mode of reading becoming the least tiring and faster in as far as the time required for reading is involved. In the text of FIG. 7 certain sets of words have been selectively written in bold letters so as to draw the attention of the reader since they contain important notions according to the writer's view.

FIG. 8 shows the same traditional text of FIG. 3 wherein certain sets of words of the text that in accordance with the writer need particular attention of the reader have been typed in bold letters.

FIG. 9a, in illustration of the reading benefit obtained through application of the invention, shows a line of text being written in the traditional mode, whilst FIG. 9b and FIG. 9c depict the same line being divided in two and three equal parts respectively.

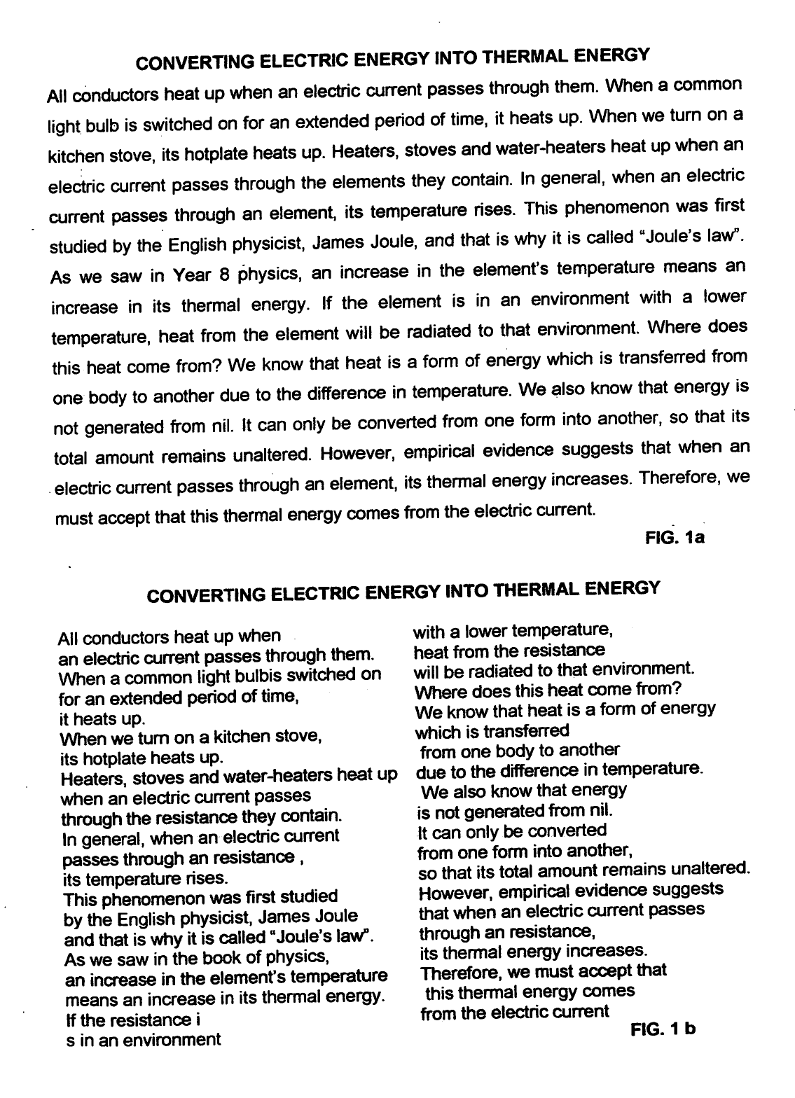

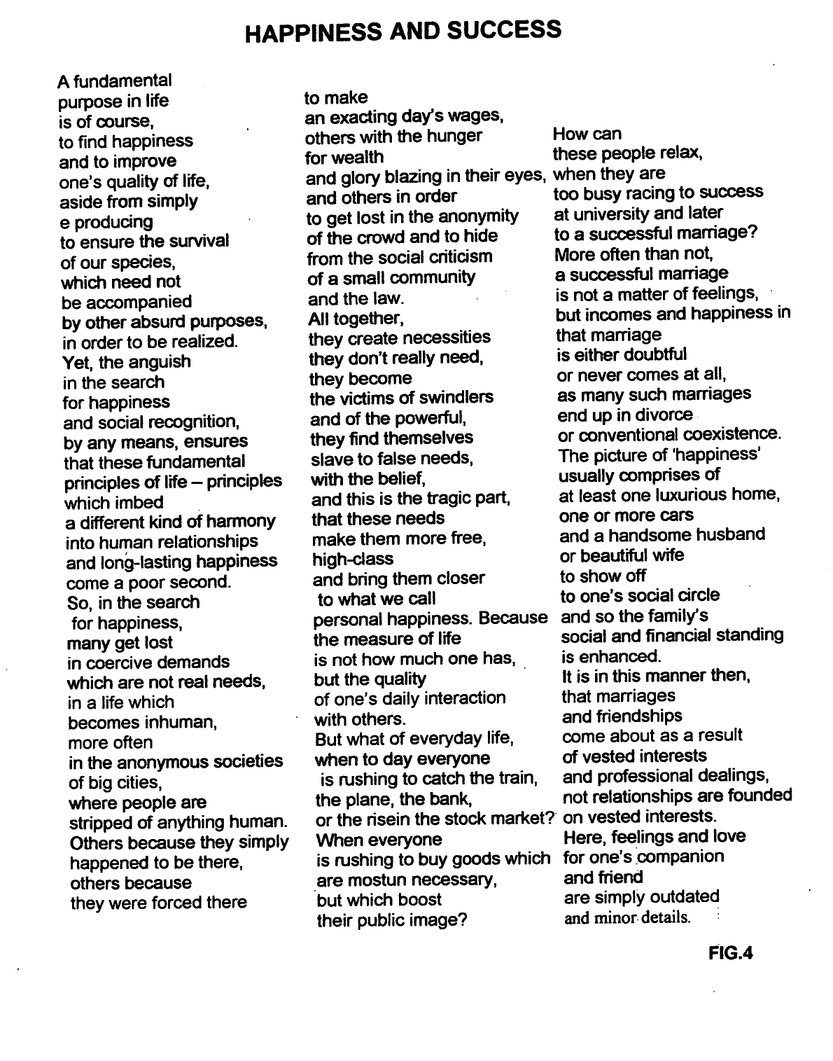

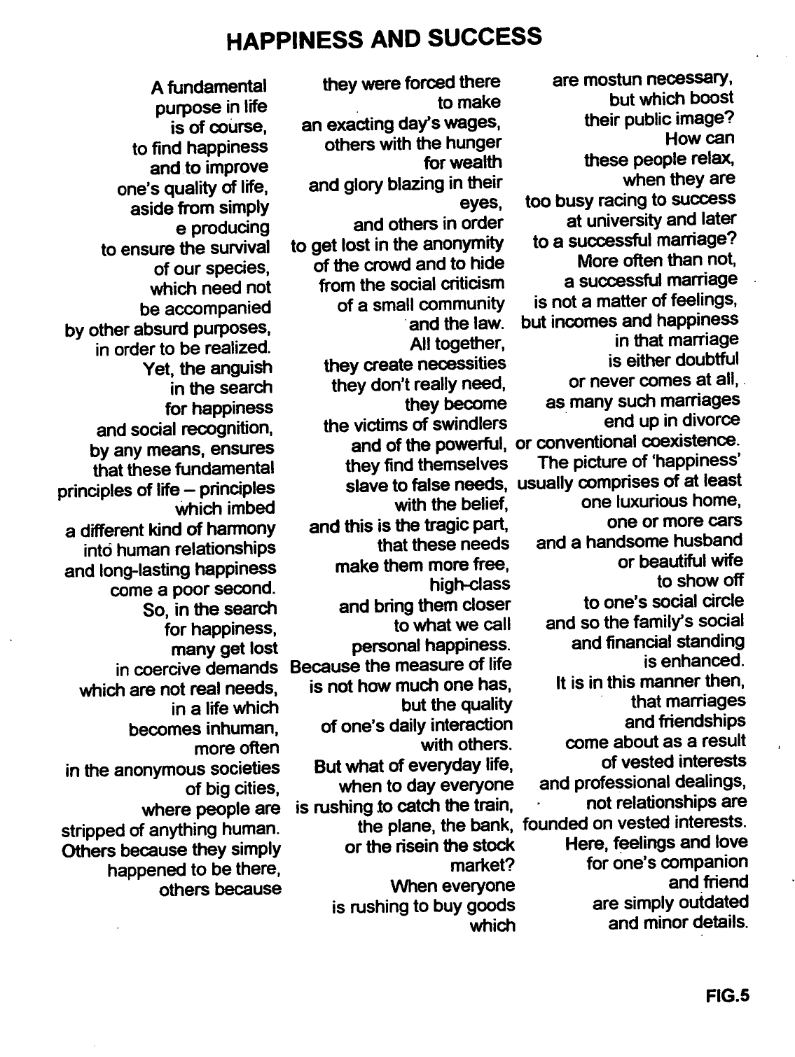

With regards to the area which is occupied by the texts printed in columns, as in the texts reformed into columns in FIG. 1b of the first model text and FIG. 1a, and the texts also reformed into columns in FIGS. 4, 5, 6 and 7 in the 2^{nd} model text, we can observe that each one is spread over approximately the same area of the page as that which was occupied by the texts in their traditional form, with small spacing for the texts in columns.

Dividing texts into columns is easy to do using the programs available on computers.

The method proposed herein of producing easier comprehensible and faster readable texts overcomes many of the fundamental disadvantages of traditional script, such as the strain on the reader's eyes and the brain, the low speed at which the texts are read, the difficulty encountered by the reader in fully understanding the texts. Furthermore, this method has advantages which cannot be found in traditional texts. The advantages are outlined in more detail herein below:

1. The reader is relieved of the strain on his eye muscles, which he would normally be subjected to in order to be able to see clearly while reading word by word. Here, due to the short length of the lines in the columns, the distance of the words from the reader's eyes does not change dramatically and so the lenses of the eyes do not need to adjust as mentioned above (FIG. 1b and FIG. 2a and FIGS. 4, 5, 6 and 7).

2. There is reduced strain on the reader's brain and it is relieved of sending so many commands. In line with the above paragraph, the adjustments made by the lenses of the eyes are no longer necessary, therefore the brain does not need to be occupied in sending commands.

3. The text is read at a greater speed, as, in line with the above paragraphs, the procedure involved in reading the texts is now streamlined.

4. Reading is made easier, faster and more comfortable when the text is in columns, as the total distance the reader has to skim is greatly reduced.

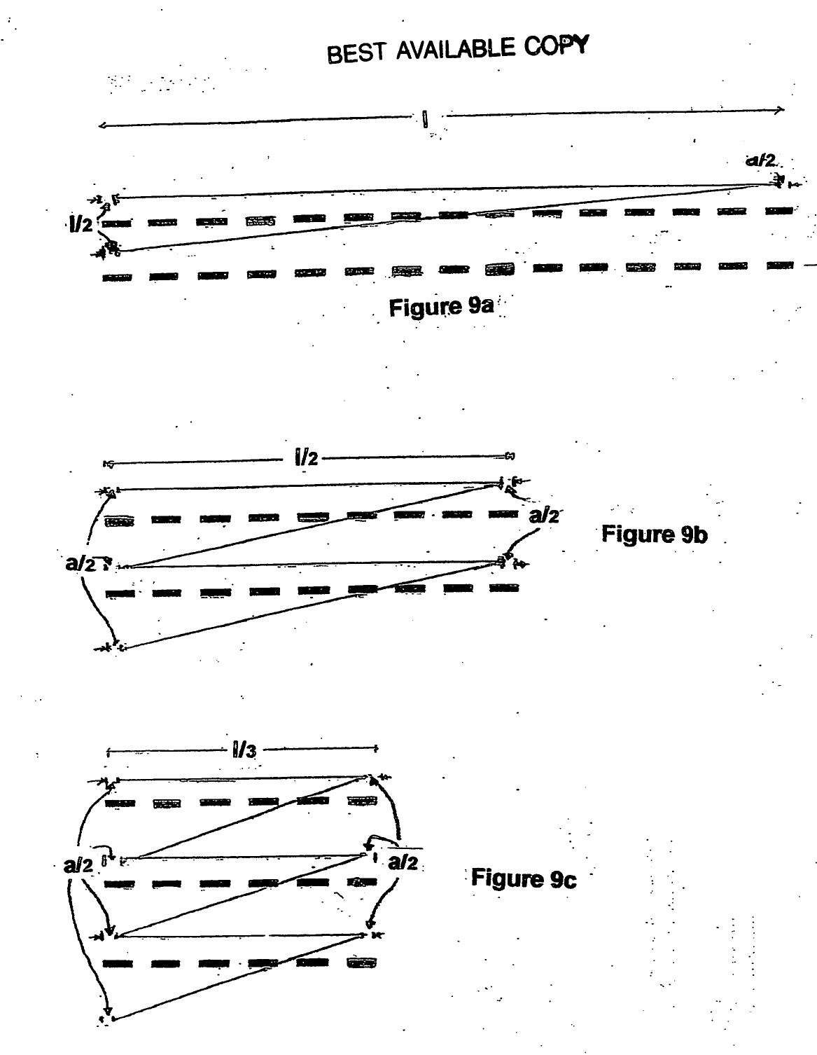

In FIG. 9a, we can see a line of text, which takes up the whole width of the page, aside from its margins, and its length is equal to 1. Normally, in order for this line to be read, the reader has to begin by focusing on the middle of the first word and finish by focusing on the middle of the last word and then return to the middle of the first word of the next line, to prepare to read that line. Therefore, this distance is equal to
−a/2+I−a/2−a/2+I−a/2=2I=2I−2a
If we divide this line into two equal parts, we end up with the text in FIG. 9b, which comprises of two equal lines. The length of each is equal to I/2 and in order for this text to be read, according to the above, the reader must skim over a distance equal to:
4[−a/2+I/2−a/2]=2I−4a
Therefore, the reader will skim over a distance, which is shortened in comparison with the distance of the first line, by the length of two words. If we divide this line into three equal parts, we end up with the text in FIG. 9c, which comprises of three equal lines.
The length of each of these lines is equal to I/3. In order for this text to be read, according to the above, the reader must skim over a distance equal to: 6[−a/2+I/3−a/2]=2I−6a:
Therefore, the reader will skim over a distance, which is shortened in comparison with the distance of the first line by 4a, i.e. by the total length of four words. We can conclude that if, for example, we take the first line of the 1^{st} model [draft 1], which has 11 words, and divide it into 2 lines, the distance that the reader has to skim is reduced by 2/11=18.8%. If the same line of the 1^{st} model is divided into three lines, then the distance that the reader has to skim is reduced by 4/11=36.36%.

5. The text is made easier to comprehend, as, according to paragraphs 1 and 2 above, the reader's brain is relieved of the strain and has more time to devote to comprehending the text, rather than sending commands to the lenses of the eyes to make adjustments.

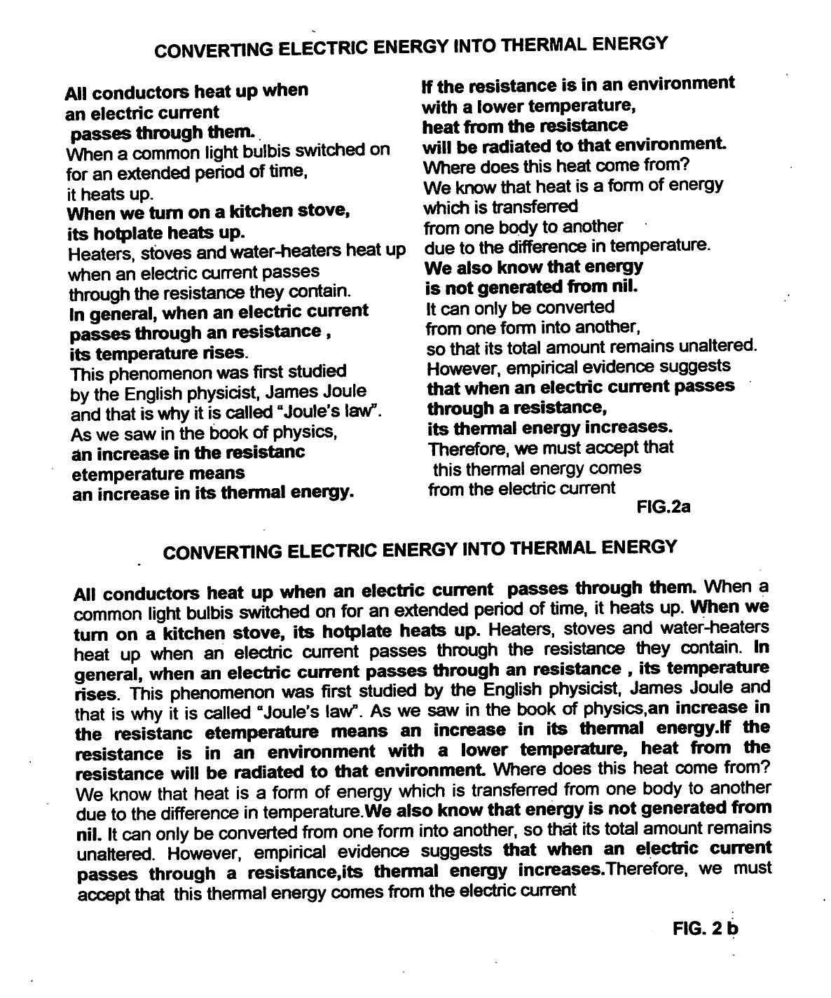

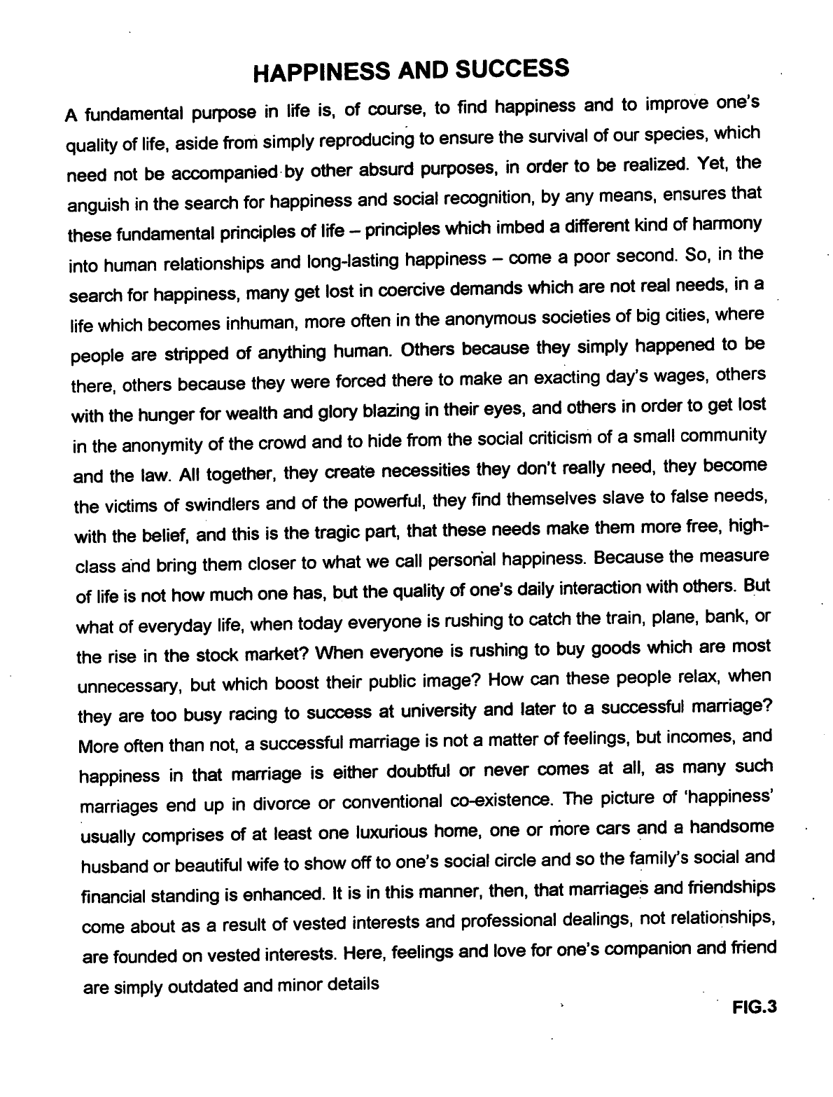

6. The text is also made easier to comprehend by dividing the phrases of the text into lines in each column so that each one of these lines represents a partial or complete concept. Therefore, comprehending the whole text is limited only to the composition of these lines, as in FIG. 1b, FIG. 2a and FIGS. 4, 5, 6 and 7.

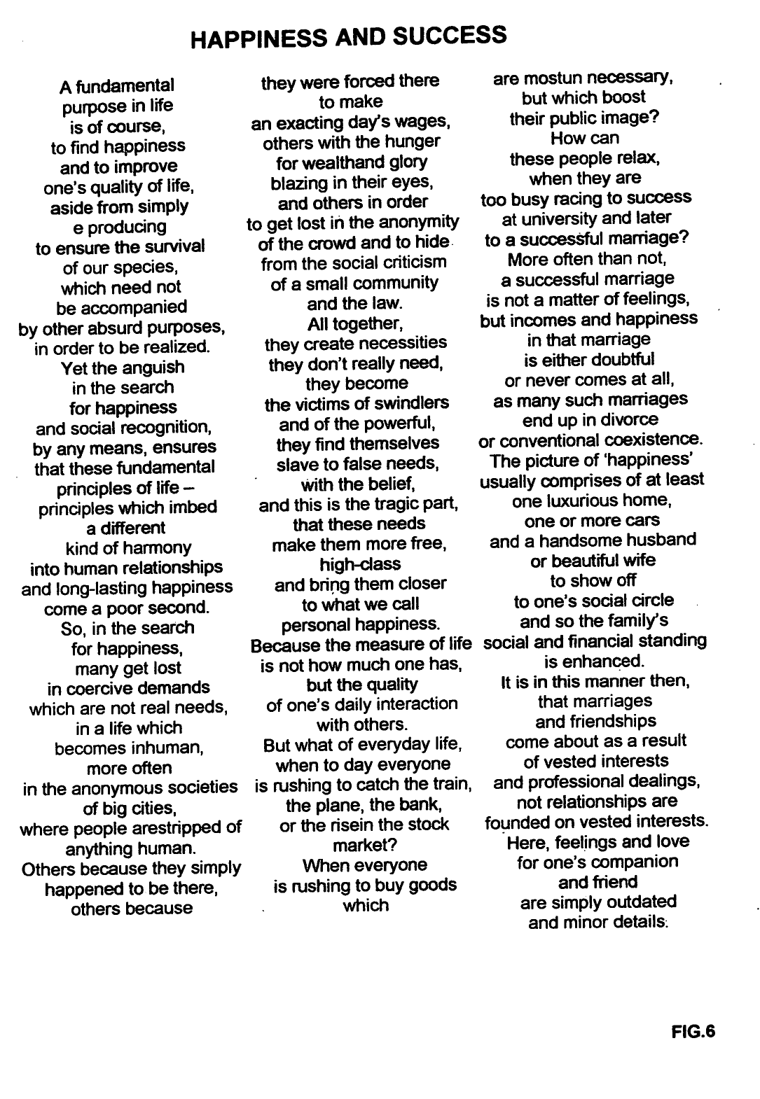

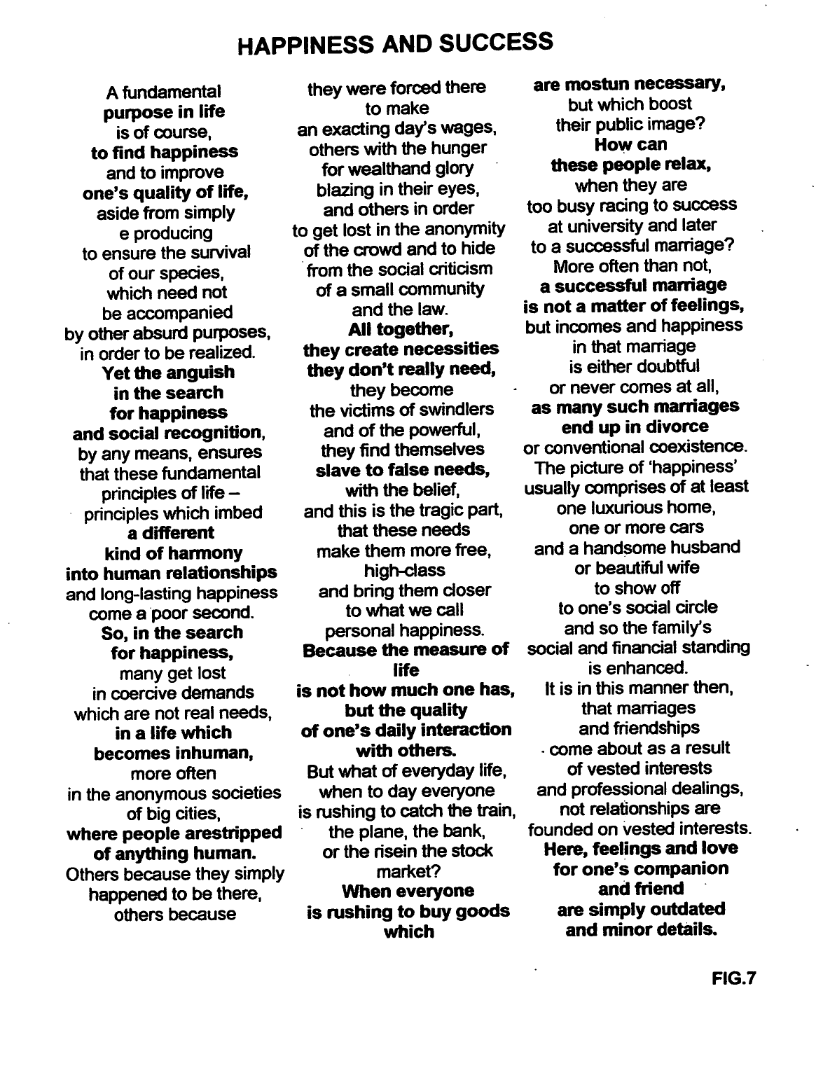

7. The speed at which the text is read is increased and is read much more comfortably when it is laid out in columns because the length of the lines is small and included in the active part of the reader's optical field. It has been observed, after becoming accustomed to such texts, that the reader skims the column virtually in a straight line from the top to the bottom, with only small deviations left and right. This develops over time and with more practice, whereby the reader then skims the text in almost a straight line and the text is read faster and more comfortably. This result can be achieved sooner by reading the texts in columns as in the models of FIGS. 6 and 7, in which the first and last letter in each line form a vertically extending axis of symmetry and this axis is followed by the reader's glance as he reads these lines.

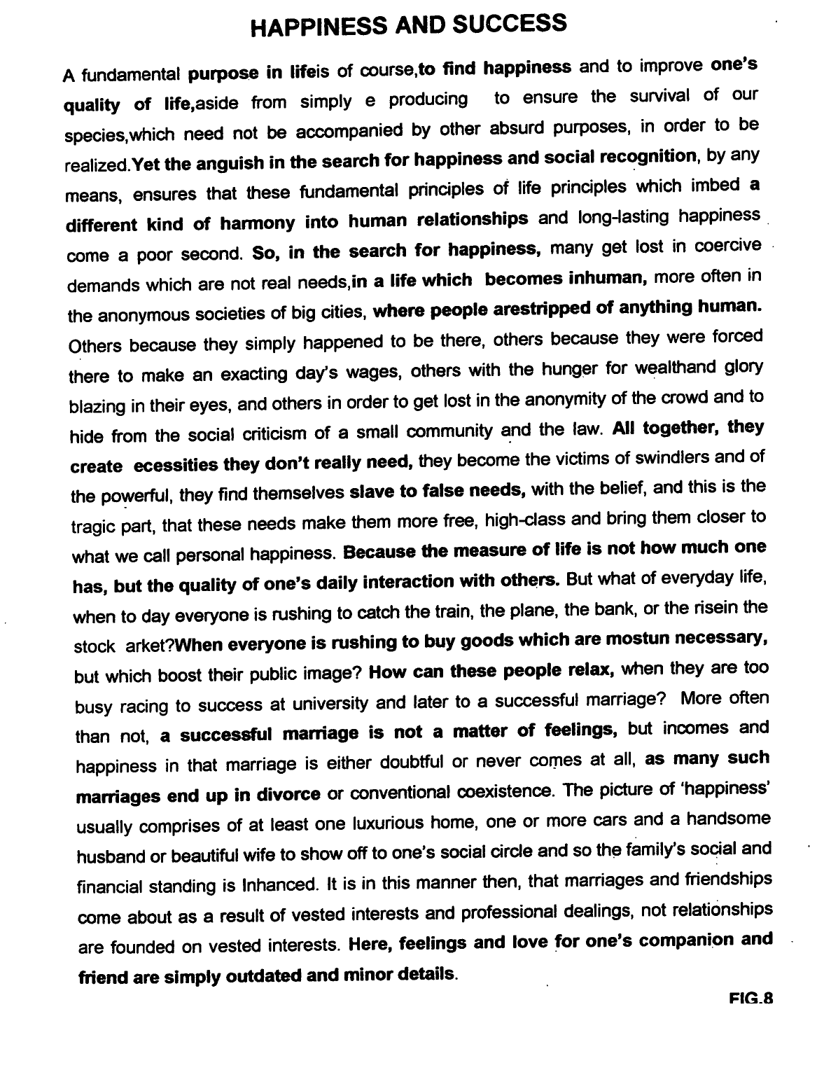

8. Any type of text can be summarized in this way as one reads selected parts thereof. These parts consist of single words and sets of successive words of the text, which are selected in such a way as to give a summary of the gist of the text. They are also printed using a different font or color, or in any other way, so as to stand out from the other words of the text and be easily read. The summaries of the texts laid out in columns as in FIG. 2a and in FIG. 7 can be easily read as the letters of the selected words and phrases are printed in bold. The summaries of traditional texts in FIG. 2b and in FIG. 8 can be just as easily read. These summaries can be of use to younger and older students and, in general, to all those who wish to have or to memorize key or brief elements of a text printed using the traditional script or that proposed herein.

1. Method of producing easier comprehensible, faster readable and more relaxed texts, characterized in that the texts are arranged in a columnar notional mode comprising apportionment of the phases contained in the original text in sets comprising one or more consecutive words, said sets of words constituting in themselves self-sufficient or partial notional entities, such as small clauses, the subject of a clause with one or more adjectival complements, the object of a clause with one or more adjectival complements, the verb with one or more adverbs thereof, individual words that must be emphasized, said sets of words being contained in consecutive lines of text in the order in which they appear in the phrase out of which they originated and in which order they are being read, said sets of words thereby forming columns and the corresponding texts produced by this method by means of equipment of any kind whatsoever, such as printing devices, electronic devices, projector devices.

2. Method of producing texts according to claim 1, characterized by that each line in each column comprises as small a number of words as possible so that the overall distance covered by the eyes of the reader during reading of the entire text may be as short as possible.

3. Method of producing texts according to claims 1 and 2, characterized by that all beginnings of lines in each column lie along a straight line that is normally oriented to the common direction of these lines.

4. Method of producing texts according to claims 1 and 2, characterized by that all ends of lines in each column lie along a straight line that is normally oriented to the common direction of these lines.

5. Method of producing texts according to claims 1 and 2, characterized by that all geometrical means of lines in each column lie along a straight line that is normally oriented to the common direction of these lines and constitutes an axis of symmetry thereof, wherein said straight line, following a certain habituation of the reader in the reading of texts of this form, may comprise the linear course along which the eyes of the reader move during reading of this column without deviating either to the right or to the left for more relaxed reading.

6. Method of producing texts according to claims 1, 2, 3, 4 and 5, as well as of texts of any other form whatsoever, characterized by that selected words and sets of consecutive words of the text are chosen in a manner such that if they are selectively read in the order that they appear in the text they render a broad or abbreviated summary of the text, wherein, with a scope of facilitating their selective reading, said selected words and sets of consecutive words are written in letters of another font or in ink of another colour or are printed in any other manner so as to differentiate from other words in the text.

7. Texts produced in accordance with the method claimed in above claims 1-6.
